(19) United States
(12) Patent Application Publication
(10) Pub. No.: US 2011/0033072 A1
(43) Pub. Date: Feb. 10, 2011

(54) HEARING AID

(76) Inventor: Masakazu Mori, Ehime (JP)

Correspondence Address: WENDEROTH, LIND & PONACK L.L.P., 1030 15th Street, N.W., Suite 400 East, Washington, DC, 20005-1503, US

(21) Appl. No.: 12/988,112

(22) PCT Filed: Feb. 8, 2010
(86) PCT No.: PCT/JP2010/000747

§ 371 Date: Oct. 15, 2010

(30) Foreign Application Priority Data
Feb. 20, 2009 (JP) 2009-038374
Oct. 6, 2009 (JP) 2009-232364

(51) Int. Cl. H04R 25/00

(52) U.S. Cl. 381/322

(57) ABSTRACT

A hearing aid (10) comprises a main body (11) that can be latched to the upper part of the base of the user's auricle, and is continuous to the rear of said base, the main body (11) having two main faces (12, 13) that are opposite the user's head and auricle and face in mutually opposite directions, a side face (14) that is adjacent to the two main faces (12, 13) and is exposed on the rear side of the user's ear and the upper side of the user's ear, a plurality of microphone holes (16, 17) that are disposed in a space (15) near the upper end of each of the main faces (12, 13) in a usage state, a battery cover (18) that is provided to the side face (14) and can be opened and closed, and convex portions (19, 20) provided to the main faces (12, 13) in the space (15) portion.

### TECHNICAL FIELD

The present invention relates to a hearing aid with which the hearing aid function is enhanced by amplifying and outputting collected sound, and more particularly relates to a BTE (Behind-The-Ear) hearing aid.

### BACKGROUND ART

There is a hearing aid in which a battery cover is provided to the bottom part of the main body, and a protrusion forming part is provided for opening and closing the battery cover. With a hearing aid such as this, when the battery needs to be replaced, the battery cover is opened by placing a finger on the protrusion forming part that protrudes from the outer surface, and then the battery is replaced (see, for example, Patent Literature 1).

### CITATION LIST

### Patent Literature

Patent Literature 1: Japanese Laid-Open Patent Application H9-215097 (FIG. 1, claim 1)

### SUMMARY

With the hearing aid disclosed in the above-mentioned Patent Literature 1, a problem is that it is difficult for the user to open the battery cover during replacement of the battery when the method employed is merely to place a finger on a protrusion forming part that protrudes from the outer surface.

Specifically, with the hearing aid of Patent Literature 1, most of its users are elderly people who may have trouble with fine motor skills. Accordingly, decreased metabolism in these users tends to result in dry skin on the hands, and this, coupled with the difficulty these users have in grasping small objects, makes it difficult for them to open the battery cover of the hearing aid. In particular, modern hearing aids have been becoming increasingly small and lightweight, which makes them even harder for users to grasp, and this compounds the difficulty of opening the battery cover.

The present invention was conceived in order to solve the above problem, and it is an object thereof to provide a hearing aid with which battery replacement can be carried out more easily.

The hearing aid pertaining to the present invention comprises a main body that can be latched to the upper part of the base of the user's auricle, and can be disposed to the rear of said base, the main body having two main faces that are opposite the user's head and auricle, respectively, a side face that is adjacent to the two main faces and is exposed on the rear side of the user's ear and the upper side of the user's ear, a plurality of microphone holes that are disposed a specific distance apart near the upper end of each of the main faces in a usage state, a battery cover that is provided to the side face and can be opened and closed with respect to the main body, and convex portions provided to the main face portion between the plurality of microphone holes.

With the present invention, when the battery cover is opened for battery replacement, the user opens and closes the battery cover with the fingers of the right hand, for example, while holding the upper part of the hearing aid with the fingers of the left hand. Here, the user can securely support the hearing aid with the left hand by hooking the fingers of the left hand on the convex portions. Therefore, the hearing aid is less likely to slip from the hand in which it is being held, so the user can more easily perform battery replacement with the right hand.

The hearing aid pertaining to the present invention is also the hearing aid discussed above, wherein the convex portions are provided continuously with the main face portion between the plurality of microphone holes.

With the present invention, convex portions are disposed in the space between microphone holes disposed near the upper ends of the main faces. Therefore, the convex portions are disposed continuously with the position that is easiest to hold near the upper ends of the main faces, which means that the anti-slip effect is enhanced, and the hearing aid can be held more securely by an elderly user or the like.

The hearing aid pertaining to the present invention is also the hearing aid discussed above, wherein the convex portions are formed so as to avoid being directly above the plurality of microphone holes.

With the present invention, since the convex portions are not disposed directly above the microphone holes, sound brought in through the microphone holes will not be blocked.

Also, it is preferable if the convex portions are provided continuously with the main face portion between the plurality of microphone holes, and are designed so that their height gradually increases from the two ends toward the center.

Consequently, an anti-slip effect can be obtained, and a decrease in the acoustic characteristics of the microphone can be avoided.

### BRIEF DESCRIPTION OF DRAWINGS

FIG. 1 is a side view of the hearing aid in a first embodiment pertaining to the present invention;

FIG. 2 is a side view in which the battery cover of the hearing aid shown in FIG. 1 has been opened;

FIG. 3 is a side view in which a replacement battery has been installed in the battery cover of the hearing aid shown in FIG. 1;

FIG. 4 is a side view of the usage state of the hearing aid shown in FIG. 1;

FIG. 5 is a rear view of the usage state of the hearing aid shown in FIG. 1; and

FIG. 6 is an oblique view of the hearing aid in a second embodiment pertaining to the present invention, as seen in front three-quarter view.

### DESCRIPTION OF EMBODIMENTS

The hearing aid pertaining to embodiments of the present invention will now be described through reference to the drawings.

In the following description, the layout of the members of a hearing aid 10 is specified using “front view, side view, etc., in a mounted state,” with “front view in a mounted state” referring to a case in which the view is from the front of the user's face, and “side view in a mounted state” referring to a case in which the view is from the side of the user's face.

### First Embodiment

The hearing aid 10 that is a first embodiment of the present invention is a BTE hearing aid, which can be latched to the upper part of the base 3 of the auricle 2 of a user 1, and comprises a main body 11 that is continuous with the rear of the base 3.

The main body 11 has two main faces 12 and 13, a side face 14, two pairs (each comprising a plurality) of microphone holes 16 and 17, a battery cover 18, and a pair of convex portions 19 and 20 in the form of protrusions. The two main faces 12 and 13 are opposite the auricle 2 and the head 4 of the user 1, and face away from each other. The side face 14 is disposed adjacent to the two main faces 12 and 13 and is exposed on the rear side of the ear 5 of the user 1 and on the upper side of the ear 5 of the user 1. The two pairs (each comprising a plurality) of microphone holes 16 and 17 are disposed with a space 15 in between near the upper ends of the main faces 12 and 13. The pair of protruding convex portions 19 and 20 are each provided in the space 15.

Specifically, the microphone holes 16 and the microphone holes 17 are disposed with a specific space in between, near the upper ends of the main faces 12 and 13 in the usage state. In other words, the microphone holes 16 and 17 are formed in the upper area of the main faces 12 and 13 not overlapping with the auricle 2 in a side view of the state in which the user has put on the hearing aid 10.

The convex portions 19 and 20 are provided to the main face 12 and 13 portions between the microphone holes 16 and the microphone holes 17. In the description of this embodiment, directions such as up, down, left, and right refer to the direction in the orientation in which the hearing aid 10 is used in a state in which the user is standing.

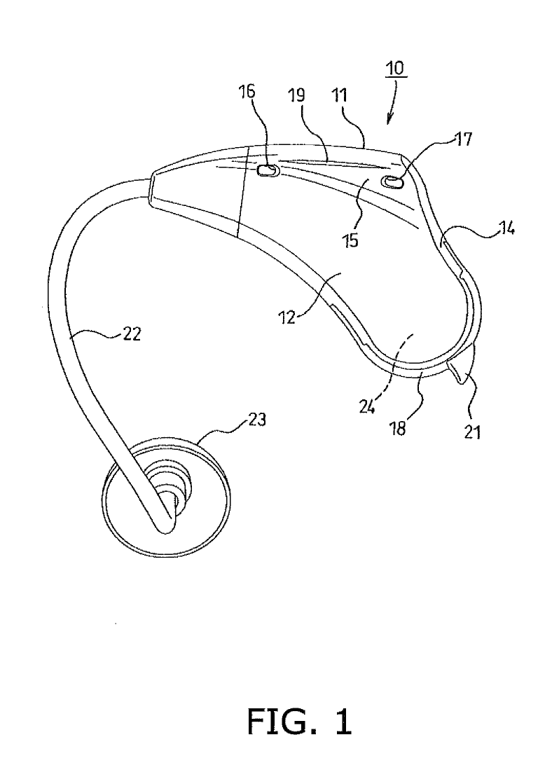

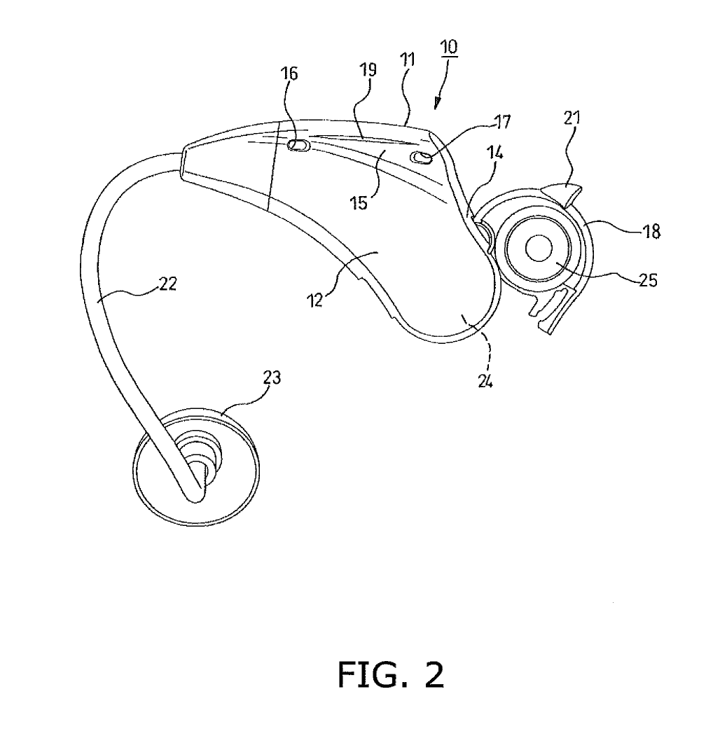

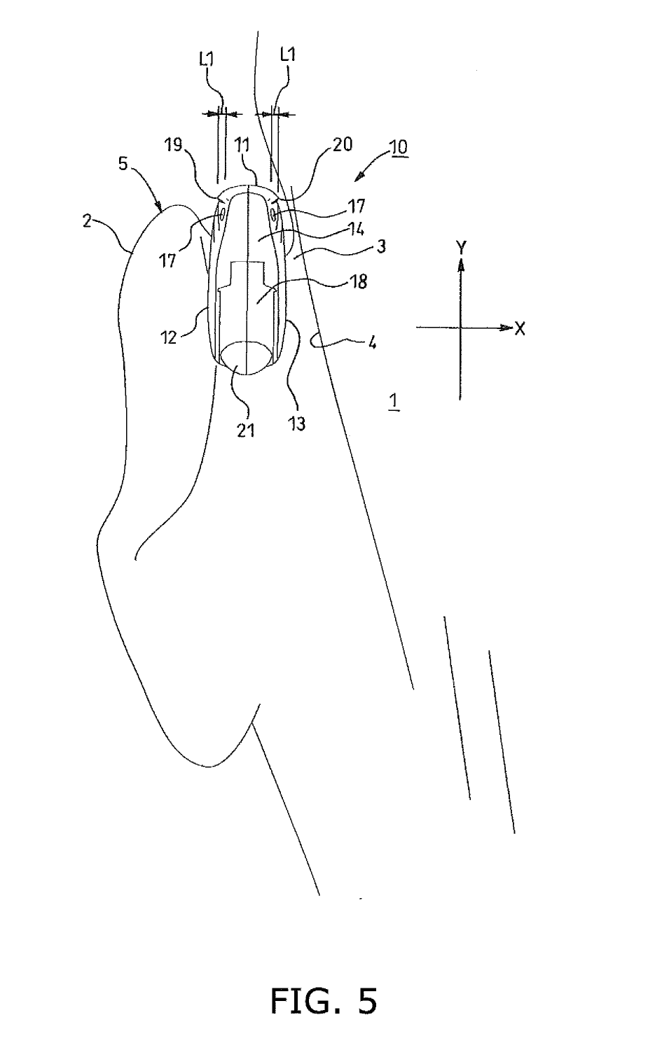

As shown in FIG. 1, the main body 11 is substantially teardrop shaped in the front view of FIG. 1. The main faces 12 and 13 are formed in a shape that is in left and right symmetry in a side view from the right side in FIG. 2 (see FIG. 5).

Although not depicted, the inside of the main body 11 includes two microphones for converting speech signals into electrical signals, a hearing aid processing circuit for amplifying the output signals from the microphones and subjecting them to hearing aid processing, an earphone circuit for converting the output signals of the hearing aid processing circuit into speech signals, and so forth.

The two microphones provided inside the main body 11 are attached to the main faces 12 and 13, respectively, in the main body 11. The two microphones are provided such that they are aligned horizontally on the front side of the ear 5 when the hearing aid 10 is worn on the ear 5. Consequently, the microphone directionality is enhanced by aligning the plurality of microphones horizontally.

The two pairs of microphone holes 16 and 17 are disposed corresponding to the two microphones. The two microphone holes 16 and 17 are preferably provided to the main faces 12 and 13 rather than the side face 14. The reason is that this helps keep perspiration and other such moisture from penetrating the device. The microphone holes 16 and 17 are spaced apart by about 10 mm.

The shape of the microphone holes 16 and 17 is substantially elliptical, with the major axis disposed along the lengthwise direction, that is, the horizontal direction. Because the two microphones are attached to the upper side of the main faces 12 and 13, the effect of sound interference and so forth caused by the main body 11 can be suppressed.

The convex portions 19 and 20 are substantially fin shaped, and are formed continuously along the lengthwise direction with the space 15 portions of the two microphone holes 16 and 17 on the main faces 12 and 13. The fin shape of the convex portions 19 and 20 is such that the fins are thicker in the middle and tapered at the end. The convex portions 19 and 20 are disposed so as not to reach the area near the microphone holes 16 and 17. Consequently, the convex portions 19 and 20 are not disposed near the microphone holes 16 and 17, which avoid the problem of blocking sound going into the microphone holes 16 and 17 that would otherwise be caused by the convex portions 19 and 20 disposed near the microphone holes 16 and 17.

In a state in which the hearing aid 10 is worn, the convex portions 19 and 20 have a length of about 10 mm (roughly 8 to 12 mm) in the horizontal direction. This is a value that is obtained from a range of at least 10 mm, which is equivalent to about one-half the width of the index finger of the user 1, and no more than 15 mm, which is equivalent to about one-half the width of the thumb of the user 1. This value corresponds to the pitch of the microphone holes 16 and 17. The above-mentioned dimensions were obtained by reference to “The Measure of Man and Woman: Human Factors in Design, Revised Edition” (by Alvin R. Tilley, edited by Henry Dreyfuss Associates, published by John Wiley & Sons, Incorporated, December 2001). Specifically, the convex portions 19 and 20 are set to a spacing that is favorable from an ergonomic standpoint.

The battery cover 18 is provided to the side face 14 of the main body 11, and has a hook-shaped opening and closing-use protrusion forming part 21 that is compressed when the battery cover 18 is opened or closed.

An ear hook 22 is a tubular member that is connected at a first end to the front end of the main body 11 in a state in which the hearing aid 10 is worn, and is bent substantially in an arc shape.

An ear canal insertion portion 23 is mounted to a second end on the ear hook 22 on the opposite side from the first end, and is inserted into the ear canal of the user in a state in which the hearing aid 10 is worn.

As shown in FIG. 2, when the battery is to be replaced, the user 1 holds the hearing aid 10 in his hand, and in this state, holds the upper part of the main body 11 of the hearing aid 10 with the fingers of the left hand (not shown), for example. Then, the battery cover 18 is opened by pressing the opening and closing-use protrusion forming part 21 of the battery cover 18 counter-clockwise from below in the drawing with the fingers of the right hand (not shown).

At this point, in a state in which the hearing aid 10 is worn, the user 1 can hook the fingers of his left hand, for example, on the convex portions 19 and 20, which are formed at the positions that are easiest to hold near the upper ends of the main faces 12 and 13. Consequently, hooking the fingers of the left hand onto the convex portions 19 and 20 means that the hearing aid 10 can be held more securely than with a conventional hearing aid that has no convex portions 19 and 20. Naturally, the operation of the left and right hands may be reversed.

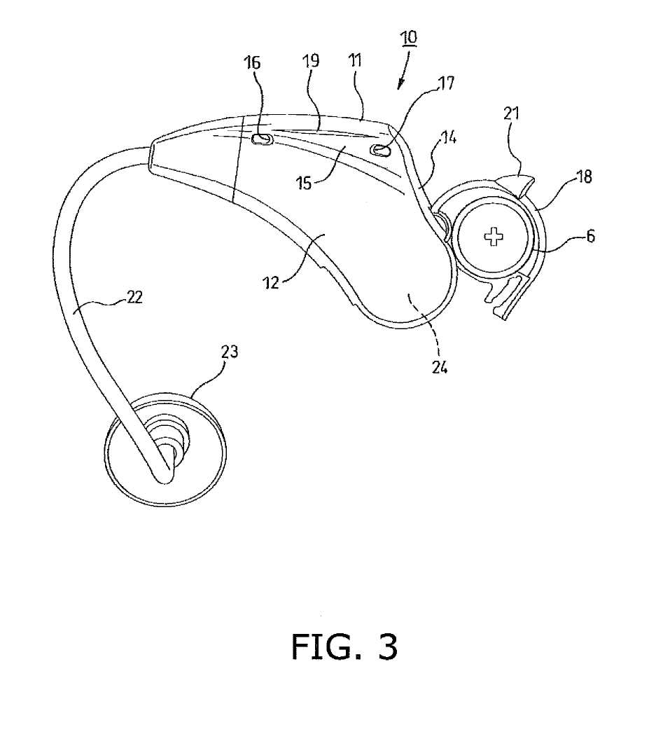

When the opening and closing-use protrusion forming part 21 is pressed from below in the drawing with the fingers of the right hand, the battery cover 18 turns on a hinge (not shown) at the upper end portion, and a battery holding part 24 opens out. The battery cover 18 has a negative terminal 25 that is electrically connected to the negative-side contact of a battery 6 (see FIG. 3) on the side face that is exposed to the outside upon counter-clockwise rotation. The battery holding part 24 has a positive terminal (not shown) disposed opposite the negative terminal 25.

As shown in FIG. 3, when the battery cover 18 is open, the used battery is replaced with a fresh battery 6. Then, in the reverse of the opening operation, the opening and closing-use protrusion forming part 21 is pressed from above in the drawing and the battery cover 18 is closed.

How the hearing aid 10 is used will now be described.

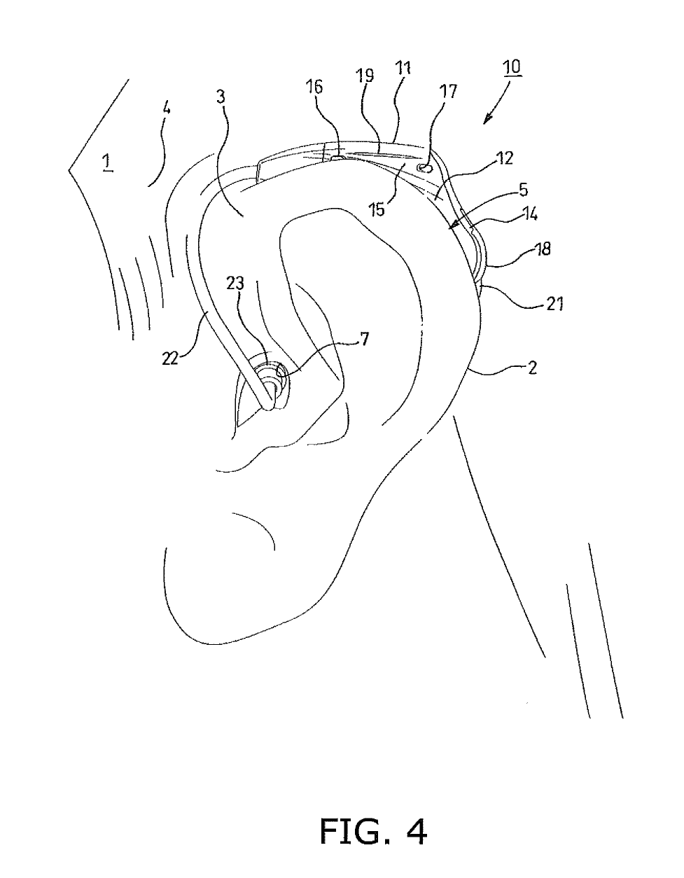

As shown in FIG. 4, when the user 1 needs help with his hearing, he latches the ear hook 22 to the upper part of the base 3 of his auricle 2. He then inserts the ear canal insertion portion 23 into his ear canal 7, operates a switch (not shown), and starts using the device.

As shown in FIG. 5, the hearing aid 10 is formed so that the width (thickness) of the side face 14 decreases from bottom to top, so that the two main faces 12 and 13 of the main body 11 are in partial contact with the auricle 2 and the head 4, respectively, in a state in which the user 1 is wearing the hearing aid 10.

As shown in FIG. 5, the convex portions 19 and 20 are designed so that their height L1 in the X direction is set to be 0.5 mm at most, for example, so that the distal end positions in the X direction (in the horizontal direction in a worn state) will be more to the inside than the maximum thickness of the hearing aid 10. Therefore, there is no risk that the convex portions 19 and 20 will come into contact with the auricle 2 and the head 4, respectively, which would cause the user 1 discomfort.

If only the anti-slip effect is considered, the convex portions 19 and 20 may be disposed in the middle (the thickest portion) of the main faces 12 and 13 of the hearing aid 10.

However, if they are disposed in the middle of the main faces 12 and 13, there is the danger that the convex portions 19 and 20 will touch the auricle 2 and the head 4 when the hearing aid 10 is put on, which would cause the user 1 discomfort. Therefore, the convex portions 19 and 20 are preferably not provided in the middle of the main faces 12 and 13. Accordingly, in this embodiment the convex portions 19 and 20 are provided near the upper ends of the main faces 12 and 13, and the surface in the middle part of the main faces 12 and 13 is made flat.

With the hearing aid 10 of the first embodiment, when the battery cover 18 is opened to replace the battery 6, the user 1 holds the upper part of the hearing aid 10 with the fingers of his left hand, for example, while opening and closing the battery cover 18 with the fingers of his right hand. The hearing aid 10 can be securely held with the fingers of the right hand by hooking the fingers of the left hand onto the convex portions 19 and 20. Therefore, the device is less likely to slip, and the replacement of the battery 6 can be carried out more easily.

With the hearing aid 10 of this embodiment, the convex portions 19 and 20 are disposed in the space 15 portion between the microphone holes 16 and 17 disposed near the upper ends of the main faces 12 and 13. Therefore, the convex portions 19 and 20 are disposed continuously in just the desired length so that the anti-slip effect is enhanced at the positions that are easiest to hold near the upper ends of the main faces 12 and 13, which means that the main body 11 of the hearing aid 10 can be held securely even by an elderly user or the like.

Also, with the hearing aid 10 of the first embodiment, the convex portions 19 and 20 are not disposed directly over (or near) the microphone holes 16 and 17. That is, the convex portions 19 and 20 are formed in the space 15 portion, which is the area between the microphone holes 16 and the microphone holes 17. However, the convex portions 19 and 20 are formed continuously in a length that does not reach all the way to the microphone holes 16 and 17, and the convex portions 19 and 20 are not present in the portion directly over (or near) the microphone holes 16 and the microphone holes 17.

This prevents the convex portions 19 and 20, which are provided for anti-slip purpose, from being formed along the path where sound is taken into the microphone holes 16 and 17 and posing an obstacle. Therefore, the sound that is supposed to be taken into the hearing aid 10 is properly taken into the microphone holes 16 and 17 without the convex portions 19 and 20 getting in the way.

Also, the convex portions 19 and 20 are designed in a peaked shape such that the height L1 (see FIG. 5) gradually rises from the ends of the convex portions 19 and 20 (the microphone holes 16 and 17 side) toward the middle. Even if the portion directly over the microphone holes 17 is not a portion that forms a convex portion, if the convex portions 19 and 20 are present around the periphery of the microphone holes 17 there is the risk that they will adversely affect the acoustic characteristics of the microphone. With this embodiment, however, the height of the end portions of the convex portions 19 and 20, which are located nearest the microphone holes 16 and 17, is reduced as much as possible, so this adverse effect can be avoided. Therefore, with the hearing aid 10 of this embodiment, providing the convex portions 19 and 20 affords an anti-slip effect, and a decrease in the acoustic characteristics of the microphones can also be avoided.

### Second Embodiment

Next, the hearing aid in a second embodiment of the present invention will be described.

In the following second embodiment, those constituent elements that are the same as those in the first embodiment discussed above, or constituent elements that are functionally the same, will be numbered the same or with equivalent numbers in the drawings in order to simplify or abbreviate the description.

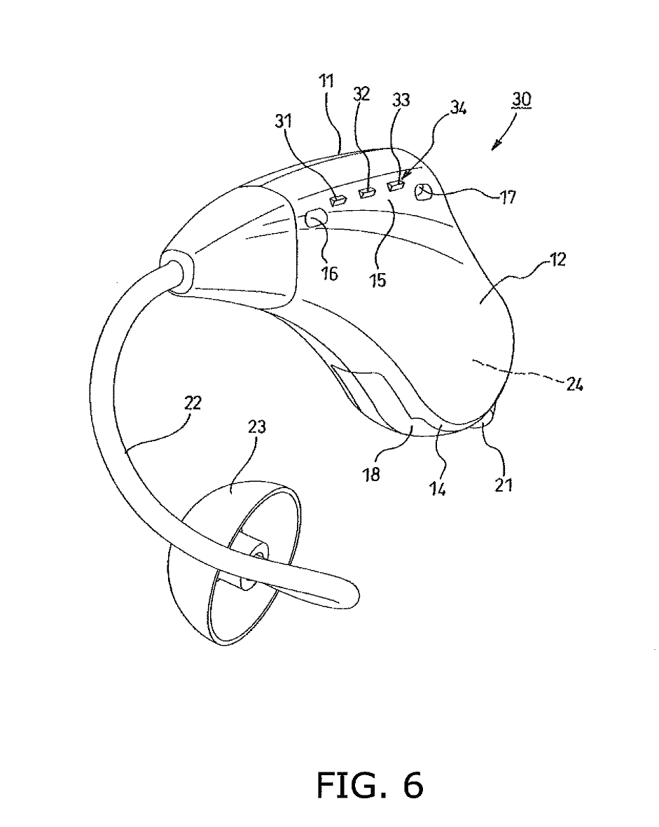

As shown in FIG. 6, with the hearing aid 30 in this embodiment, a convex portion 34 consisting of a plurality of small protrusions 31, 32, and 33 is provided in the area (space 15) between a pair of microphone holes 16 and 17.

The small protrusions 31, 32, and 33 are each formed in the shape of a triangular prism, and are formed non-continuously and equidistantly in the space 15 portion between the microphone holes 16 and 17 on main faces 12 and 13. The small protrusions 31, 32, and 33 each have a length of about 1 to 3 mm in the lengthwise direction in a state in which the hearing aid 30 is worn.

Again with the hearing aid 30 of this second embodiment, just as with the convex portions 19 and 20 of the hearing aid 10 in the first embodiment, the anti-slip small protrusions 31, 32, and 33 are provided near the upper ends of the main faces 12 and 13. Therefore, a constitution can be obtained in which the small protrusions 31, 32, and 33 do not come into contact with the auricle 2 or the head 4, which would cause the user 1 discomfort. Also, the portion of the main faces 12 and 13 directly over the microphone holes 16 and the microphone holes 17, or the portion nearby, serves as an area in which the small protrusions are not formed. Therefore, the small protrusions 31, 32, and 33 will not pose an obstacle to sound that is supposed to be taken in by the hearing aid 30, and prevent make it difficult for this sound to go into the microphone holes 16 and 17.

With the hearing aid 30 of this embodiment, in addition to the action and effect of the first embodiment discussed above, because there is a convex portion 34 consisting of a plurality of small protrusions 31, 32, and 33, when the battery cover 18 is opened, there will be greater friction with the fingers of the left hand, for example, in the lengthwise direction when the hearing aid 30 is worn, making it easier to grab on.

The microphone holes 16 and 17, the ear hook 22, the ear canal insertion portion 23, and so forth used in the first and second embodiments above are not limited to what were given as examples, and modifications can be made as needed.

Also, in this embodiment, the convex portion 34 (the small protrusions 31, 32, and 33) is formed on both of the main faces 12 and 13. However, the small protrusions 31, 32, and 33 may be provided to just one of the main faces. When the small protrusions 31, 32, and 33 are provided to just one of the main faces, they are preferably provided to the main face 12 that is opposite the auricle (FIG. 5). The auricle is more flexible than the head, so even if the small protrusions 31, 32, and 33 or the like should touch it, they will be unlikely to cause discomfort.

Further, even though the convex portions 19 and 20 or the small protrusions 31, 32, and 33 are provided to the upper ends of the hearing aids 10 and 30 as in the first and second embodiments above, they will tend to come into contact with the head or auricle as the hearing aids 10 and 30 become smaller, so there are situations in which it will be preferable to provide them to just one of the main faces.

The hearing aid of the present invention may also be constituted as follows.

A hearing aid that can be latched to the upper part of the base of the user's auricle, and can be worn between the rear side of the auricle and the temple of the user, comprising:

a main body into which a sound collecting microphone is built;

a plurality of microphone holes that communicate with the sound collecting microphone, and that are disposed a specific distance apart at a position that does not overlap the auricle on the surface of the main body in a side view of a state in which the hearing aid is worn;

a battery holding part provided in the main body;

a battery cover that is attached so as to cover a opening in the battery holding part, and can be opened and closed with respect to the main body when a specific location is pressed; and

a convex portion that is an area on the surface of the main body away from the plurality of microphone holes, and that is provided at a position that is away from the temple and the auricle of the user in a state in which the hearing aid is worn.

Furthermore, the hearing aid of the present invention more preferably has the following constitution.

The above-mentioned hearing aid,

wherein the microphone holes are provided to the upper area of the main body in a state in which the hearing aid is worn by the user, and

the convex portion is disposed so as to avoid the area near the microphone holes.

### Other Embodiments

(A)

In the above embodiment, an example was described in which the side face 14 of the hearing aid 10 was formed as a separate face from the main faces 12 and 13, but the present invention is not limited to this.

For instance, the constitution may be such that the main faces and side face of the hearing aid are formed continuously with no boundary in between them.

(B)

In the above embodiment, an example was described in which the side face 14 of the hearing aid 10 was a curved face, but the present invention is not limited to this. For instance, the side face of the hearing aid may be formed in a flat shape.

(C)

In the above embodiment, an example was described in which the anti-slip convex portions 19 and 20 were formed in the upper area of the microphone holes 16 and 17 on the main faces 12 and 13 of the hearing aid 10, but the present invention is not limited to this. For instance, the region in which the convex portions are formed is not limited to the above-mentioned area, and may instead be formed in another area, such as the upper face of the hearing aid.

Here again, the same effect as in the above embodiments can be obtained as long as this location is a position where the convex portion has an anti-slip function for the holding hand during battery replacement, and is a position where the convex portion does not hit the temple or auricle in a state in which the hearing aid is worn, and the convex portion does not pose an obstacle to sound entering the microphone holes.

### INDUSTRIAL APPLICABILITY

With the present invention, since battery replacement can be carried out with ease, this invention can be widely applied to hearing aids of various shapes and sizes.

### REFERENCE SIGNS LIST

1 user
2 auricle
3 base
4 head
5 ear
10, 30 hearing aid
11 main body
12, 13 main face
14 side face
15 space
16, 17 microphone holes
18 battery cover
19, 20, 34 convex portion

1. A hearing aid, comprising a main body that can be latched to the upper part of the base of the user's auricle, and can be disposed to the rear of the base,
the main body having:
two main faces that are opposite the user's head and auricle, respectively;
a side face that is adjacent to the two main faces and is exposed from the rear side of the user's ear to the upper side of the user's ear;
a plurality of microphone holes that are disposed a specific distance apart near the upper end of each of the main faces in a usage state;
a battery cover that is provided to the side face and can be opened and closed with respect to the main body; and
convex portions provided in the upper area of the main face portion in the usage state, between the plurality of microphone holes, and
the convex portions being formed so as to avoid the upper area of the microphone holes in the usage state and
wherein the convex portions are provided continuously with the main face portion between the plurality of microphone holes and are formed so that their height gradually decreases from the center toward the two ends.

2. (canceled)

3. (canceled)

4. (canceled)
